(19) United States
(12) Patent Application Publication
(10) Pub. No.: US 2017/0251626 A1
(43) Pub. Date: Sep. 7, 2017

(54) Household animal litter box with bladder that collects drained liquid waste

(71) Applicant: James Garard Finney, Kingston, NH (US)

(72) Inventor: James Garard Finney, Kingston, NH (US)

(21) Appl. No.: 15/442,632

(22) Filed: Feb. 25, 2017

Related U.S. Application Data
(60) Provisional application No. 62/302,356, filed on Mar. 2, 2016.

(51) Int. Cl. A01K 1/01

(52) U.S. Cl. CPC A01K 1/0107

(57) ABSTRACT

A pet litter box with a sloped floor holding a quantity of non-absorbent litter and a drain in the low part of the floor that connects by tubing to a liquid waste collection bladder. The pet litter box having legs at four corners or a supportive structural skirt at its perimeter to maintain space between the floor of the pet litter box and the resting surface. The bladder is made of a flexible, impermeable material and is positioned below the drain in the floor of the pet little box to allow the flow of liquid waste from the drain through flexible tubing into the bladder. The tubing can be disconnected from the bladder to allow draining of the bladder into a toilet or other disposal container.

### CROSS-REFERENCE TO RELATED APPLICATIONS

This application claims the benefit of U.S. Provisional Application No. 62/302,356 filed Mar. 2, 2016.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

1. Field of the Invention

The present invention relates to pet litter boxes for small household animals, and more specifically relates to a pet litter box that stores liquid waste in a flexible bladder.

2. Background

There are many problems with available systems used to provide toileting opportunity for household pets. The most conventional systems of animal litter boxes use a rigid tray into which is placed a quantity of particulate clay which clings to deposited solid waste and into which urine is absorbed. For consumers the clay is cumbersome to transport from a store and is an expense because it is discarded and must be purchased as a continuous supply. It harms the environment because it fills landfills and must be mined often from strip mines which do great harm to an ecosystem. Malodorous volatiles waft constantly into the air from the exposed urine, necessitating frequent changes to the litter. Often, much of the clay particles have not been saturated with urine before the odor drives an early change of litter, wasting the clay that has yet to be saturated. Dry clay and urine-saturated clay clings to the paws of the pets and is then carried throughout the home, to be deposited by chance upon any surface upon which the animal alights, including human bedding. That the feces and urine are deposited together and intermingle causes additional biological activity which creates additional unpleasant odor. More recently, a binder has been added to the clay so that the litter clumps together into removable chunks when liquid is deposited. The clumps frequently break apart and spread throughout the tray, which promulgates the problem of odor and exacerbates the problem of the transport of urine-saturated clay particles on the paws of the pet throughout the household. Furthermore, this does not in any way mitigate the problem of strip mined clay and the resultant harm to the ecosystem surrounding the mine. Neither does it reduce cost, or eliminate the increased waste of non-reusable litter. Attempts have been made to reduce the odor and decrease the time burden for cleaning the litter box by automation of the process using actuated scoopers or automated washing of a reusable litter. These solutions are complicated, expensive, use electricity or plumbed water, can frighten the household animal into refusing to use the litter box, and have a host of failure points which have led to reports ranging from poor performance to damage to the surrounding area by failed valves, overflow, and flooding of wash water. Some solutions have been attempted in which a reusable litter is used and the liquid waste absorbed by a pad. This is costly, produces a large amount of product waste, takes significant time to frequently change the pad, and does not sufficiently mitigate the problem of odor in that the urine has a large surface area in contact with the air which allows for ample creation of odor.

It would be desirable to have a household animal toileting device which provides a maximal interval between each instance when the liquid and solid waste must be removed from the device. Furthermore, it would be desirable to have an animal toileting device which minimizes the malodorous emanations associated with stored animal waste and provides a convenient and hygienic way to empty the device of the waste. Still further, it would also be desirable to have an animal toileting device which relies solely on non-disposable components to reduce expense and waste, and which relies on natural forces such as gravity, rather than electrically activated components or pumped water to achieve these ends. Therefore, there currently exists a need in the industry for an animal toileting device which can be conveniently and hygienically emptied of waste, which relies principally on non-disposable components to reduce expense and waste, which minimizes unpleasant odors without reliance on electricity or an outside source of plumbed water, and which maximizes the interval between removal of the waste from the device.

### SUMMARY OF THE INVENTION

The present invention advantageously fills the aforementioned deficiencies by providing a household animal litter box with bladder that collects drained liquid waste. It accomplishes this without reliance on disposable components. Furthermore, it should be noted that the bladder has sufficient capacity to allow repeated use of the device by an animal before the bladder must be emptied by disconnection from the other components and emptying into a drain or suitable container. It can be reconnected to the other components for continued use.

The present invention is an animal litter box in which a household animal can toilet, which is made up of the following components: a rigid, impermeable box having a floor and four upright walls, the walls of which are sufficiently low for an animal to step over to gain entrance to the interior of the box, but high enough to contain a quantity of non-absorbent litter, and a rigid floor which will support the weight of an animal and a quantity of non-absorbent litter, the floor having multiple facets or a contour which slopes downward at a sufficient angle to promote the flow of urine to a lower plane in the floor at which the sloped facets of the floor converge, and having an interior and exterior surface; supportive legs or a supportive surrounding skirt which will maintain the stability of the box at an elevation above the resting surface of the invention sufficient to promote the draining of liquid waste by gravity through flexible tubing from the box to a distal point from the box but sufficiently low as to allow a household animal to proceed from the resting surface of the invention to within the four walls of the litter container; a multiple of small openings in the lowest plane of the floor, through which urine can flow, but which are sufficiently small to prevent the passage of litter; a funnel attached to the exterior surface of the floor of the container such that it encircles the multiple of small openings and diverts liquid waste to flow out through a single small opening at the lowest point in the funnel; a flexible, impermeable tube which will conduct the urine from the funnel terminus to a bladder by the force of gravity upon liquid from higher in the tube to a location lower and distal to the funnel; a waterproof connector through which urine can flow and which prevents leaking of the urine when connected, but which allows evacuation of the urine bladder when disconnected; a flexible, impermeable bladder into which the urine passes to be stored until disconnected from the tubing and emptied into a drain or other suitable receptacle. These components are connected as follows: The litter container box is affixed to and supported by the legs or is supported by a supportive skirt such that the litter container box is elevated and stable above the resting surface. The funnel is permanently and rigidly attached to the exterior surface of the lowest facet of the floor of the box, and attached such that the multiple of small openings comprising a drain in the floor is completely circumscribed on the exterior surface by the interface of the wide end of the funnel and the box. The flexible, impermeable tube is attached to the narrow terminus of the funnel such that the liquid waste flows by gravity from the interior of the funnel through the single narrow opening of the funnel and into the tube. The tube is attached to a connector which allows the flow of the liquid waste from the tube into the bladder when connected to the bladder. The flow of the liquid waste from the litter container box terminates in the impermeable flexible bladder and is stored until the bladder is disconnected from the tubing to be emptied in a drain or some other suitable container and then reconnected for additional use.

The present invention is superior to other known inventions because it: (1) can use re-usable litter materials and device components and the only waste created is that of the household animal (2) reduces odor because it segregates the liquid waste and solid waste from each other (3) reduces odor because it minimizes surface area interface between the air and the deposited urine (4) eliminates contact with the urine when emptying the urine containment portion of the device (5) is a passive device which relies on gravity for the segregation and storage of the liquid waste (6) reduces carriage of the litter on the paws of the household animal by allowing use of non-disposable litters which are heavier than typical disposable litters (7) eliminates the ecological damage caused by strip mining of clay for use in animal litter (8) eliminates the risk of overflow and urine damage of surroundings because the flexible bladder and tubing system will not release excess urine by overflow once the maximum capacity of the system is reached and (9) eliminates any need for a vent of the containment portion of the device because the bladder is flexible and can expand in proportion to the increasing volume of the deposited urine.

The present invention is unique in that it is structurally different from other known devices or solutions. More specifically, the present invention is unique due to the presence of: (1) flexible, impermeable tubing which conducts the flow of deposited liquid animal waste; (2) funnel which collects the liquid waste and conducts it to the tubing from the multiple small openings through which the liquid animal waste drains; (3) flexible, impermeable bladder into which the liquid waste flows and is stored; (4) spatial relationship between the litter box component and the liquid waste container in that the two components can be located a distance from each other with the tubing guiding the flow of liquid waste from the litter box to the bladder; (5) the minimization of the surface area of the interface between the air and the liquid waste constrained either by the diameter of the funnel at the level at which the liquid waste settles or the narrow diameter of the tubing when the level of the liquid waste settles below the funnel; and (6) the connector placed at a point in the tubing which allows for the separation of the two portions of the tubing.

Among other things, it is an object of the present invention to provide a household animal litter box with bladder that collects drained liquid waste that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a perspective view showing a preferred embodiment of a pet litter box according to the present invention.

FIG. 2 is a cross-sectional view showing an embodiment of FIG. 1, taken along line 2-2.

FIG. 3 is a perspective view showing the inferior surface of the tray of the invention shown in FIG. 1.

### DETAILED DESCRIPTION OF THE INVENTION

Embodiments of the present invention will be described herein below in conjunction with the accompanying drawings. However, the invention is not limited by this description.

In this invention, the term “pets” means household small animals such as dogs, cats, rabbits, or rodents. Also, the term “litter” means a mass of particulate materials formed of natural or synthetic substance which may be spherical or irregularly shaped. Furthermore, the term “liquid” means all fluid mass in liquid phase which is excreted as waste by pets and is capable of passing through litter of the present invention. The term “non-absorbent” means that liquid will flow over or around but not be retained within the non-absorbent feature.

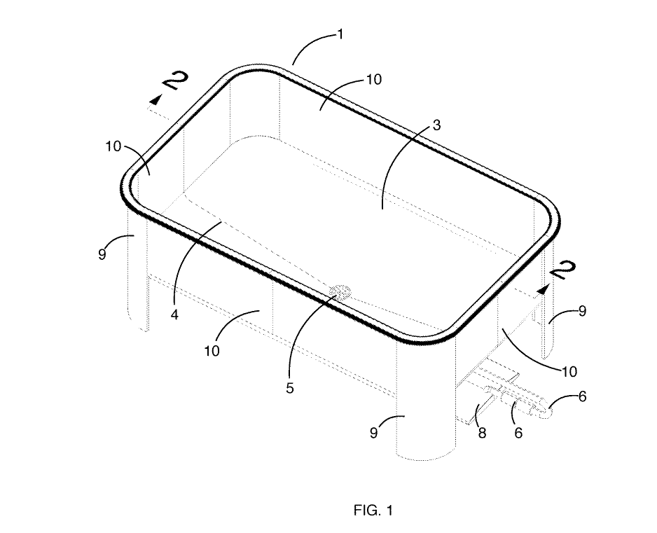

In a pet litter box according to an embodiment, as shown in FIG. 1, an animal litter box comprising an elevated tray 1 with vertical upward walls 10 with a floor 3 of predetermined size, the floor having a contour 4 sloping downward to the lowest point in the floor in which is an integrated drain 5 which accumulates liquid waste and allows the passage of liquid into flexible tubing 6 and a connector 7 which conducts liquid into a flexible, impermeable bladder 8 which expands to accept the entry of liquid waste. The tray is upheld by a supporting structures 9.

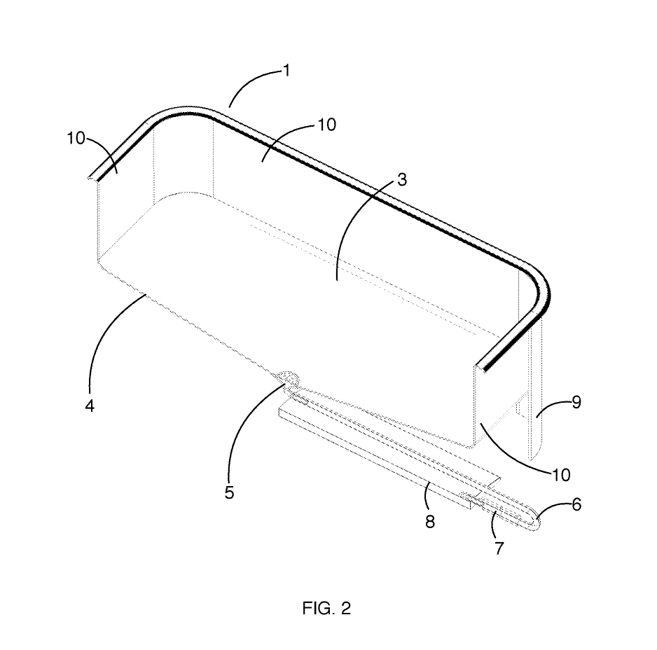

FIG. 2 shows a cross-sectional view from sight-line 2 of FIG. 1 of an elevated tray 1 with vertical upward walls 10 with a floor 3 of predetermined size, the floor having a contour 4 sloping downward to the lowest point in the floor in which is an integrated drain 5 which accumulates liquid waste and allows the passage of liquid into flexible tubing 6 and a connector 7 which conducts liquid into a flexible, impermeable bladder 8 which expands to accept the entry of liquid waste. The tray is upheld by supporting structures 9.

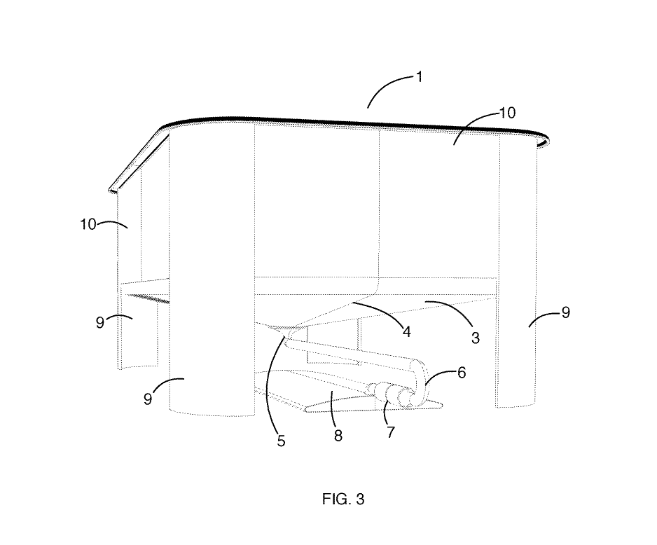

FIG. 3 shows the inferior surface of the invention shown in FIG. 1. There is an elevated tray 1 with vertical upward walls 10 with a floor 3 of predetermined size, the floor having a contour 4 sloping downward to the lowest point in the floor in which is an integrated drain 5 which accumulates liquid waste and allows the passage of liquid into flexible tubing 6 and a connector 7 which conducts liquid into a flexible, impermeable bladder 8 which expands to accept the entry of liquid waste. The tray is upheld by supporting structures 9.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. An animal litter box comprising an elevated tray with four vertical upward walls comprising a perimeter with a floor of predetermined size sufficient for holding a quantity of litter and an animal, the floor having a contour or plurality of facets sloping downward to the lowest point in the floor into which are one or more integrated drains which accumulate liquid waste and allow the passage of liquid into flexible tubing which connects into a flexible, impermeable bladder which expands to accept the entry of liquid waste.

2. The animal litter box of claim 1 wherein said flexible tubing has a connector which permits the bladder to be disconnected from the flexible tubing which connects to the drain of the tray.

3. The animal litter box of claim 1 wherein said drains have a flat surface with a plurality of holes or slots of a predetermined width, that width to permit the passage of liquid and also sufficiently narrow to prevent the passage of litters to be used in the tray.

4. The animal litter box of claim 1 wherein said bladder is comprised of a flexible impermeable material which is mechanically closed or permanently sealed on all edges and which has a port through which the connected tubing has a contiguous channel through which the liquid flows by gravity into the bladder.

5. The animal litter box of claim 1 wherein said bladder is shaped to permit the expansion of the internal volume which is surrounded by the bladder material and is expanded by the entry of liquid into the bladder.

6. The animal litter box of claim 1 wherein said tray is elevated above the resting surface of the invention by a plurality of legs or a rigid skirt or structure upholding the tray.

7. The animal litter box of claim 1 wherein said bladder is made of a durable, flexible, impermeable material that is permanently sealed along the entire border or permanently sealed along several borders with a mechanical clip sealing the remaining borders of the perimeter of the bladder.

8. The animal litter box of claim 1 wherein said floor is shaped to provide a constant, impermeable path for liquid to flow downward by gravity to the low point in the floor where it enters the drain and flows into the tubing.

9. The animal litter box of claim 1 wherein said floor has an integrated collecting space for liquid and provides an attachment to which is connected flexible tubing to provide a passageway for liquid to flow to the bladder

10. The animal litter box of claim 1 wherein said tray is comprised of walls and floor and drain which are contiguous and made from an impermeable material which constrains liquid to remain in the interior space of the tray and to exit the tray by gravity only through the said drain or drains in the floor of the tray.

11. The animal litter box of claim 1 wherein said tray is elevated above the resting surface of the invention at a sufficient elevation such that the lowest point of the floor of the tray is above the height of the resting surface and above the height of the liquid bladder so that liquid will flow by gravity from the relatively higher elevation of the drain to the relatively lower elevation of the liquid bladder.
